(19) United States
(12) Patent Application Publication
(10) Pub. No.: US 2024/0079617 A1
(43) Pub. Date: Mar. 7, 2024

(54) SYSTEMS AND METHODS FOR CONTROLLING AIR FLOW AT A FUEL CELL

(71) Applicant: Intelligent Energy Limited, Loughborough, Leicestershire (GB)

(72) Inventors: Christopher KIRK, Leicestershire (GB); Steven HANSER, Leicestershire (GB)

(73) Assignee: Intelligent Energy Limited, Loughborough, Leicestershire (GB)

(21) Appl. No.: 18/280,355

(22) PCT Filed: Mar. 5, 2022
(86) PCT No.: PCT/IB2022/051962

§ 371 Date: Sep. 5, 2023

(30) Foreign Application Priority Data
Mar. 5, 2021 (GB) 2103119.0

(51) Int. Cl. H01M 8/04746; B60L 58/33; B64U 50/32; H01M 8/04014; H01M 8/04089; H01M 8/0432; H01M 8/04492; H01M 8/04537; H01M 8/04701; H01M 8/04828; H01M 8/1007; H01M 8/241; H01M 8/2457

(52) U.S. Cl. CPC H01M 8/04753; B60L 58/33; B64U 50/32; H01M 8/04014; H01M 8/04089; H01M 8/0432; H01M 8/04492; H01M 8/04559; H01M 8/04701; H01M 8/04828; H01M 8/1007; H01M 8/241; H01M 8/2457; H01M 2008/1095; H01M 2250/20

(57) ABSTRACT

A system may be configured to cool and provide oxidant to an open cathode proton-exchange membrane (PEM) fuel cell (FC) stack comprising a plurality of FCs configured to operationally receive a first amount of fluid. Some embodiments may have the first amount be non-zero, and a controller may be configured to adjust the first amount such that a second amount of fluid substantially greater than the first amount is received at the FCs. The adjustment may be performed responsive to at least one of (i) a sensed attribute of one or more of the FCs changing by an amount that satisfies a danger criterion and (ii) an elapsed time of operation of the FC stack satisfying a periodicity criterion. The adjustment may cause the elapsed time to satisfy an endurance criterion.

### TECHNICAL FIELD

The present disclosure generally relates to systems and methods for substantially adjusting an amount of air flow at a surface of an open cathode fuel cell (FC).

### BACKGROUND

FCs comprise two porous electrodes (a negative electrode or anode and a positive electrode or cathode), which are sandwiched around an electrolyte (a proton exchange membrane (PEM)), together forming a membrane-electrode assembly (MEA). A reducing fuel, such as hydrogen, is fed to the anode, and an oxidant stream is fed to the cathode, to produce electrical energy. A cathode diffusion structure (e.g., a cathode gas diffusion layer) has a first face adjacent to the cathode face of the MEA, and an anode diffusion structure (e.g., an anode gas diffusion layer) has a first face adjacent the anode face of the MEA. The second face of the anode diffusion structure contacts an anode fluid flow field plate for current collection and for distributing hydrogen to the second face of the anode diffusion structure. The second face of the cathode diffusion structure contacts a cathode fluid flow field plate for current collection, for distributing oxygen to the second face of the cathode diffusion structure, and for extracting excess water from the MEA. Each of the anode and cathode fluid flow field plates comprises a rigid, electrically conductive, material traditionally having fluid flow channels in the surface adjacent the respective diffusion structure for delivery of the reactant gases (e.g., hydrogen and oxygen) and removal of the exhaust gases (e.g., unused oxygen and water vapor).

Because the reaction of fuel and oxidant generates electrical power, water, and heat, an FC stack requires cooling once an operating temperature has been reached, to avoid damage to the FCs. There are multiple ways in which this can be achieved. Open cathode FCs are cooled by their environment, either passively or using an air mover such as a fan to enhance the flow of air through the FC. Liquid cooled FCs have one or more fluidically isolated coolant loops that are able to enhance heat rejection from the stack by passing a coolant fluid between the FCs. Evaporatively-cooled fuel cell systems use the phase change of water to vapor to provide FC stack cooling.

A key function during the FC electrochemical reaction between hydrogen and oxygen is the proton migration process via the PEM. The proton exchange process will only occur when the solid state PEM is sufficiently hydrated. With insufficient water present, the water drag characteristics of the membrane will restrict the proton migration process leading to an increase in the internal resistance of the cell. With over-saturation of the PEM there is the possibility that excess water will flood the electrode part of the MEA and restrict gas access to a three phase reaction interface. Both of these events have a negative effect on the overall performance of the FC, the latter being part of a vicious cycle (e.g., with increasingly cold spots and increasing moisture build-up). The end FCs of a stack may be heated, in order to mitigate the fact that these cells are often cooler than the stack's central cells and so more prone to flooding, but failure of one or more of the FCs in the stack then becomes random. Increasing the air inlet temperature by preheating or re-circulation is a known solution, but this requires additional technology and complexity that may not be suitable in many cases (e.g., light-weight applications).

### DISCLOSURE

Aspects of systems and methods are disclosed for cooling and providing oxidant to an open cathode proton-exchange membrane (PEM) fuel cell (FC) stack, comprising a plurality of FCs. Accordingly, one or more aspects of the present disclosure relate to a method for; operationally receiving a first amount of fluid, where the first amount is non-zero; and adjusting, via a controller, the first amount such that a second amount of fluid substantially greater than the first amount is received at the FCs. The adjustment may be performed responsive to at least one of (i) a sensed attribute of one or more of the FCs changing by an amount that satisfies a danger criterion and (ii) an elapsed time of operation of the FC stack satisfying a periodicity criterion. And the adjustment may cause the elapsed time to satisfy an endurance criterion.

There are generally two architectures of fuel cells and their associated plates to facilitate these approaches to cooling. In air cooled and liquid cooled designs the cathode and anode plates are often separate components, often referred to as monopolar plates. These may be affixed by some means e.g. compression, welding, gluing etc to form an assembly. With evaporatively cooled designs each plate acts as the cathode plate for a first cell and the anode plate for an adjacent second cell, often referred to as bipolar plates. These generalized architectures are not limiting however and in some circumstances air cooled FC stacks may be comprised of bipolar plates and evaporatively cooled FC stacks may be comprised of monopolar plates. However these general observations are not intended to be limiting.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

Aspects of systems and methods disclosed herein include an open cathode proton-exchange membrane (PEM) fuel cell (FC) stack comprising a plurality of FCs configured to operationally receive a first amount of fluid, the first amount being non-zero; and a controller configured to adjust the first amount such that a second amount of fluid substantially greater than the first amount is received at the FCs, wherein the adjustment is performed responsive to at least one of (i) a sensed attribute of one or more of the FCs changing by an amount that satisfies a danger criterion and (ii) an elapsed time of operation of the FC stack satisfying a periodicity criterion, and wherein the adjustment causes the elapsed time to satisfy an endurance criterion. In some instances the adjustment causes moisture from one or more cathode side electrodes to be removed or evaporated such that the moisture does not block the fluid from diffusing to the respective electrode(s). In some instances the sensed attribute comprises at least one of a voltage and moisture indication. In some instances the performance of the adjustment is further responsive to an ambient temperature external to the FC stack satisfying a coldness criterion. In some instances the performance of the adjustment is further responsive to an ambient humidity external to the FC stack satisfying a moistness criterion. In some instances a duration of the performed adjustment is determined based on a cubic meter per minute (CMM) flow of the received fluid. In some instances the coldness criterion is 5° C. In some instances a core temperature of the FC stack is determined based on the ambient temperature.

Aspects of systems and methods disclosed herein include an open cathode proton-exchange membrane (PEM) fuel cell (FC) stack comprising a plurality of FCs configured to operationally receive a first amount of fluid, the first amount being non-zero; and a controller configured to adjust the first amount such that a second amount of fluid substantially greater than the first amount is received at the FCs, wherein the adjustment is performed responsive to at least one of (i) a sensed attribute of one or more of the FCs changing by an amount that satisfies a danger criterion and (ii) an elapsed time of operation of the FC stack satisfying a periodicity criterion, and wherein the adjustment causes the elapsed time to satisfy an endurance criterion. In some instances the duration of the performed adjustment is further determined based on (i) a time needed to ramp up from the first amount to the second amount and (ii) a time needed to ramp down from the second amount to the first amount. In some instances at least one of a duration of the performed adjustment and a periodicity of the performed adjustment is determined based on a manner in which the FC stack responded to a previous adjustment. In some instances the periodicity criterion is predetermined such that the sensed attribute is prevented from satisfying the danger criterion. In some instances the second amount is greater than the first amount by a factor of 3 or more. In some instances the fluid is received over a surface of the FC stack. In some instances the controller performs the adjustment by controlling a duty cycle of an air mover. In some instances the controller performs the adjustment by controlling at least one of a restrictor and diverter coupled to the FC stack or to a duct of the FC stack. In some instances the controller performs the adjustment by controlling a set of pressurized bellows. In some instances the system is mounted in an unmanned aerial vehicle (UAV). In some instances a fan pulse, which causes a temporary reduction in air flow by (i) temporarily stopping the fan and/or (ii) using an air blocking device, and the adjustment are synchronized such that the adjustment is performed after the fan pulse. In some instances ram air is received at the FCs, while the system is in motion, based on the control of the controller.

Aspects of systems and methods disclosed herein include an open cathode proton-exchange membrane providing an open cathode proton-exchange membrane (PEM) fuel cell (FC) stack comprising a plurality of FCs configured to operationally receive a first amount of fluid, the first amount being non-zero; and providing a controller configured to adjust the first amount such that a second amount of fluid substantially greater than the first amount is received at the FCs, wherein the adjustment is performed responsive to at least one of (i) a sensed attribute of one or more of the FCs changing by an amount that satisfies a danger criterion and (ii) an elapsed time of operation of the FC stack satisfying a periodicity criterion, and wherein the adjustment causes the elapsed time to satisfy an endurance criterion.

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1A illustrates an air-cooled open cathode fuel cell stack, in accordance with one or more embodiments.

FIG. 1B illustrates an example of a system in which air flow is controlled, in accordance with one or more embodiments.

FIGS. 2A-2B respectively illustrate an example air mover in low-flow and high-flow configurations, in accordance with one or more embodiments.

FIG. 2C illustrates an example air mover in an air sucking configuration, in accordance with one or more embodiments.

FIGS. 3A-3C respectively illustrate an example air mover in high-flow, lowest-flow, and low-flow configurations, in accordance with one or more embodiments.

FIG. 3D illustrates different types of air movers coordinated into an air sucking configuration, in accordance with one or more embodiments.

FIGS. 4A-4B respectively illustrate an example air mover in low-flow and high-flow configurations, in accordance with one or more embodiments.

FIG. 5 illustrates a process for providing substantially different amounts of air flow, in accordance with one or more embodiments.

All callouts in the figures are hereby incorporated by reference as if fully set forth herein.

### FURTHER DISCLOSURE

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly. i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

These drawings may not be drawn to scale and may not precisely reflect structure or performance characteristics of any given embodiment, and should not be interpreted as defining or limiting the range of values or properties encompassed by example embodiments.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

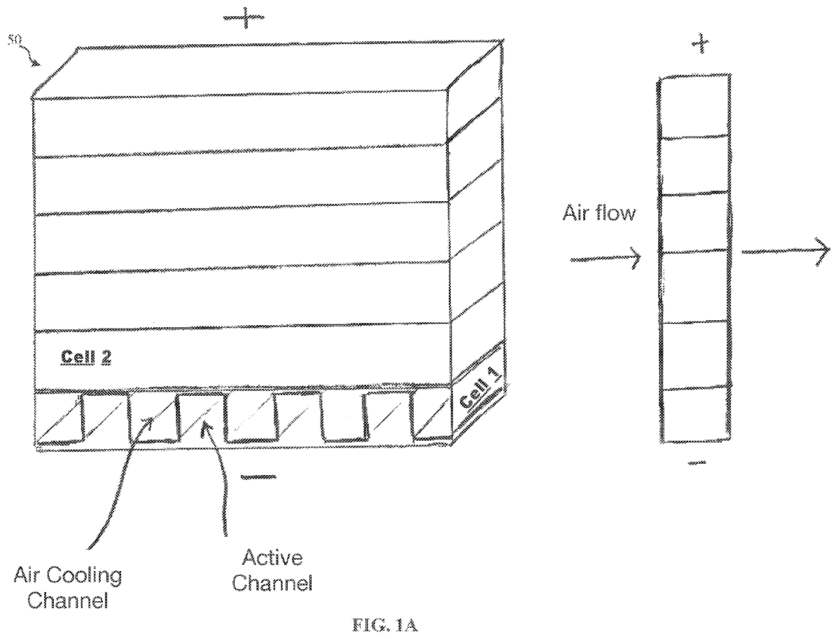

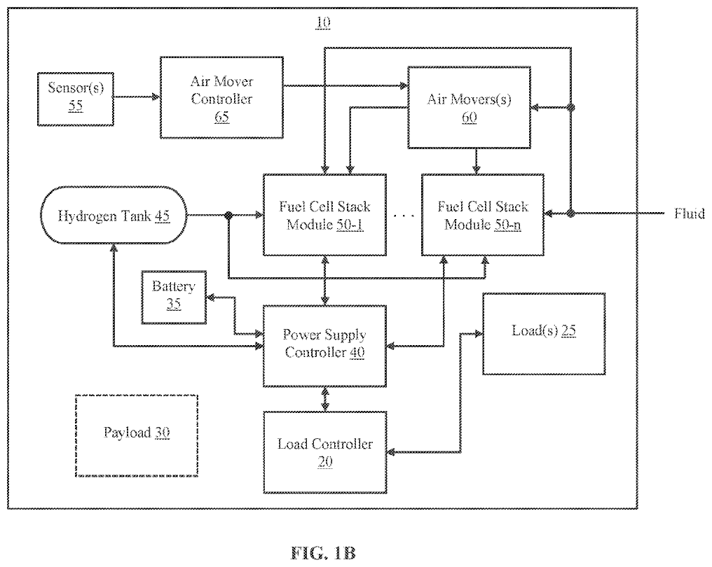

In some exemplary implementations, one or more components (e.g., fuel cell stack module(s) 50, air mover controller 65 (for controlling air mover(s) 60), sensor(s) 55, hydrogen supply 45, optional payload 30, power controller 40, load controller 20 (for controlling load 25), and battery 35) of system 10 may be affixed onto a frame or housing. FIG. 1B depicts an example of system 10.

In some exemplary implementations, system 10 may comprise an open cathode FC stack, with airflow being directed across the cathode side of each FC to provide oxidant to the cathode side of the MEA of each FC. The open cathode PEM FC stack 50 may, e.g., have cathode fluid flow field plates with channels exposed to ambient air. As such, its structure may be simple, low-cost, and have low parasitic losses.

In some exemplary implementations, open cathode FC system 10 may be self-humidified and/or air-cooled. For example, one or more air movers 60 may attach (e.g., directly or via a duct) to the FC housing, which may remove heat from the stack by forced or directed convection and may at the same time provide oxygen to the cathode.

Oxidant may be provided to stack 50 via a diffusion layer. And to achieve uniform airflow to the FCs across an entire FC stack having a plurality of FCs, airflow may be provided, e.g., across the FC stack between opposing faces of the stack. In this or another example, airflow may be provided across each FC from one edge of the FC to an opposing edge.

The herein-disclosed approach is contemplated for complementing the purging of some non-open-cathode FC implementations. But the effect may be more pronounced for open cathode FC configurations due to the cathode channel geometry for air passage being over-sized. An air-cooled open cathode FC stack showing an oversized geometry relative to airflow is depicted in the two views of FIG. 1A.

In some exemplary implementations, open-cathode FC stack 50 may have straight through cathode channels to allow for air flow provided by air movers 60. For example, an air flow (e.g., fan assisted or ram-air) may serve a purpose of providing oxygen to the cathode of the FC for reaction and at least another purpose of cooling or maintaining the FC temperature. In this or another example, an open cathode FC may have a cooling fan directly attached, removing heat by forced convection and providing oxygen to the cathode. It will be appreciated that these coolant channels may also be featured, either with structures such as bumps or fins protruding into the air flow path or by having a non-linear channel such as a sinusoidal channel so that there is no linear unobstructed air flow path through the stack.

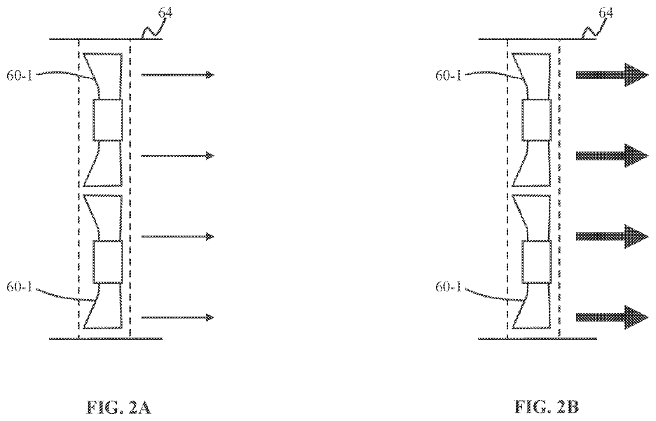

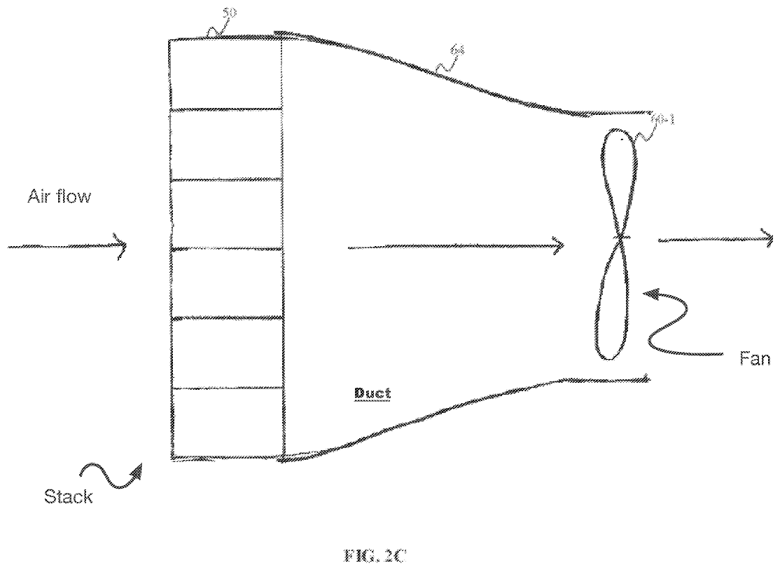

In some exemplary implementations, the fluid is provided to FC stack 50 for both a cooling function and to supply an oxidant (e.g., oxygen). In these or other exemplary implementations, air mover 60-1, 60-2, 60-3 (see FIGS. 2A-4B) may be used for one or more other functions, such as to exhaust vapor, to cool a condenser, to direct the air to the coolant module and/or catalytic heater, or to serve another purpose. The air mover may convectively act to regulate the FC stack temperature and the reactant feeding (gas stoichiometry). For example, a fine and adapted control strategy may be employed to ensure optimal balance and efficiency of the stack system, for a large range of operating conditions, such as ambient temperature, relative humidity, load current, and aging.

In some exemplary implementations, air movers 60 may cause sensor-based and/or periodic blasts of air to be directed at air-cooled FCs, e.g., when ambient temperatures at the system 10 fluid inlet are low (e.g., about 5° Celsius (C) or less), to increase evaporation rates. For example, when ambient temperatures get very low, a lot more liquid water is produced than can be otherwise managed. In these or other exemplary implementations, open-cathode, air-cooled stack 50 may have a temperature maintained (e.g., at least partly due to the air movement controlled by controller 65).

In some exemplary implementations, system 10 may be in an environment such that it has low air inlet temperatures (e.g., and heated end cells). Though target cell temperatures may be achieved, random cell failure may still occur, e.g., due to cathode flooding. That is, it has been demonstrated that even when the cell temperature is maintained at target levels using low air flow levels and end cell heaters, in some cases, random cells can become flooded on the cathode and eventually fail. If the end FCs are not heated, these are the cells within the stack which are likely to fail. Such failure may be caused by the evaporation rate in some areas of the cell still being insufficient due to a variation of temperature across the cell and/or very low airflow rates required to maintain a target operating temperature. In some exemplary implementations, by periodically increasing the air flow rate to maximum (e.g., via a fan blast), evaporation rates can be temporarily increased, to mitigate these failures and further extend run time.

When operating air cooled fuel cells with low air inlet temperatures (e.g., at or less than 5° C.), the performance is often unstable especially if cell operating temperatures cannot be maintained at a sufficient level (e.g., at or above 45° C.). This is because the evaporation rate of water produced on the cathode is insufficient at lower temperatures leading to a build-up of liquid water. This puddle of sorts may block oxygen transport to the electrode(s) of stack 50, reducing performance and eventually causing one or more FCs to fail. Without oxygen going through, the consequence may be that heat cannot be generated because there may be no electrode chemistry happening so therefore that makes that spot get even colder, resulting in a vicious cycle. An air flow adjustment may thus help by causing moisture from one or more cathode side electrodes to be removed or evaporated such that the moisture does not block the fluid from diffusing to the respective electrode(s) on the cathode side.

The vicious cycle relates to the cell heat progressively increasing (for a constant power output), as cell performance drops, which should stabilize flooding. However, as evaporation rates continue to reduce (e.g., for lower ambient temperatures), a tipping point is reached where water will build up and stable operation is no longer possible even with the increased heat generated by the cell. The cell will then fail. In other words, a combination of airflow and cell temperature are lower than the critical level, to eject water from the cathode; water builds up on the cathode, reducing the active surface area and causing oxygen diffusion to the electrode to be decreased; and then cell performance reduces until a cell eventually fails.

In some exemplary implementations, by periodically increasing the air flow to maximum for at least one second (or a few seconds), the evaporation and removal of water from the cathode may be increased. Although this causes a dramatic drop in operating temperature, stack 50 may recover quickly. The disclosed approach does not have a significant impact on water removal between air blasts, and it may result in a net gain in water removal. The blasting may be based on air inlet temperature such that no blasting is needed when the temperature is not so low and/or when an ambient humidity is not too high. For example, the blasting may begin to be (e.g., periodically) performed when the temperature is 5° C. or less, or the blasting may begin to be performed when the temperature is higher but when the humidity is also higher.

In some exemplary implementations, controller 65 may help prevent water build up by slowing down the cooling (e.g., by restricting or redistributing the airflow away or by adjusting an attribute of a fan or cooler) to make the stack run hotter, but the performed blasting may further help. For example, the controller may perform this adjustment when a sensed attribute (e.g., a voltage dropping too much, moisture indication detecting too much water, or another suitable parameter breaches a threshold) of one or more of the FCs changes to a dangerous amount or level. As a result, fluid flow may dramatically increase to a maximum capacity, for a very short time, and then turn it back down again to evaporate and/or physically move the water quicker, without significantly impacting the temperature of the FC. By only performing the adjustment for a very short amount of time, a temperature of the FC may not be cooled too much and thus may avoid causing an additional problem (e.g., a stopping of the production of liquid water).

In some exemplary implementations, the FCs may each have an air inlet to draw in oxidant and/or coolant from an environment external to system 10. One or more air movers may be provided at the air inlets to substantially draw in the air. The air inlets may be substantially driven without a fan or blower, e.g., when relying instead on motion of system 10 to draw air inward. Each FC may also have an air outlet, which may be provided downstream of the air inlet.

In some exemplary implementations, a ram-air intake of system 10 may be configured such that dynamic air pressure (e.g., which may be created by vehicular motion) increases the static air pressure inside of intake manifold 64 (see FIGS. 2A-4B), thus allowing a greater mass flow to FC stack 50. For example, system 10 may be mounted in an unmanned aerial vehicle (UAV) or another type of vehicle which may or may not be airborne.

In some exemplary implementations, system 10 may be configured to operate while stationary or in motion. For example, a set of restrictors/divertors 60-2 may be used in stationary systems where there is no ram air, and/or they may be used in mobile systems where there is ram air. In some implementations, the air flow (e.g., of the fan or otherwise) may be down to a minimum but still too much to be provided to FC stack 50. For example, in cold conditions, the set of restrictors/diverters may be engaged into a closed position with fan 60-1 spinning. Then, when wanting to perform an air blast, the fan may be left as-is; and controller 65 may then open up the restrictor/diverter. As such, ram air and a moving stack may not be necessary for performing the adjustment.

In some exemplary implementations, adjustments by air mover controller 65 may be periodic. For example, every 30 minutes or at another interval, including irregular ones such as those based on a sensor, air may be blasted at or from stack 50 for a duration of a few seconds. In this or another example, cathode flooding may begin, e.g., at around 35 minutes of elapsed time, and it may progressively get worse, e.g., until the adjustment (blast) blows the water off the cathode, at a time soon thereafter. This benefit may thus be had without need for taking on the weight of having extra equipment or a kit (e.g., a recirculation system or heaters) to resolve the same problem.

In some exemplary implementations, air mover controller 65 may comprise an elapsed time counter that triggers an output notification when the elapsed time satisfies a periodicity criterion. For example, every 30 minutes could cause air mover controller 65 to perform the adjustment.

In some exemplary implementations, adjustment(s) by air mover controller 65 may cause an elapsed time to satisfy an endurance criterion. For example, an amount of time that system 10 may be able to run may be 2 hours or longer, even with an air inlet temperature of −10° C. This elapsed time may be greater than system 10 could otherwise run had the adjustment(s) not been performed. For example, cathode flooding may occur after about 45 minutes of operation, and cell failure may occur after about 75 minutes when the adjustment(s) are not performed. Hence disclosed herein is also a method to extend the continuous operational time limits for a fuel cell powered system. In systems running on highly compressed hydrogen or frozen hydrogen (which are characterized by high energy density adequate to support these longer run times) the run time may be longer than 3 hours and may also be longer than 12 hours, and in some instances in excess of 20 hours. Thereby the method allows for extended range, particularly in ariel vehicles and said operational times exceed operational times for traditional systems.

And the adjustment, which substantially increases the flow of a fluid directed at FC stack 50, may be suddenly made without causing a temperature of stack 50 to drop by an amount that satisfies a coldness criterion. For example, a duration of the adjustment may be so short that a core temperature of stack 50 remains at about 45° C. (e.g., when an ambient temperature is greater than about 5° C.) and at about 55° C. for (e.g., when the ambient temperature is less than about 5° C.). In this or another example, the core temperature of FC stack 50 may be controlled and/or determined based on the ambient temperature (and/or on another attribute). Open cathode FC performance may be based on the operating temperature variation and the airflow rate which is adjusted. The core temperature may be the hottest temperature. e.g., which may be towards the outlet of the cell. And the core temperature number may be w % bat controller 65 attempts to control the airflow against to try and maintain this temperature.

In some exemplary implementations, without the adjustment, the voltage of one or more of the FCs may begin to drop off due to a near flooding of the electrode. As a result of the adjustment that removes accumulated moisture, the voltage may quickly increase and return to previous levels indicative of normal, healthy operation.

In some exemplary implementations, the duration of the adjustment may comprise (i) a flow ramp-up portion and a flow ramp-down portion that take up about 25% of the duration and (ii) a substantially maximum flow portion that takes up about 75% of the duration. In these or other implementations, slowly adjusting air movers may be used such that an amount of time at full blast is less because more of the adjustment time is comprised of the ramping up and down. As such, in these latter implementations, the substantial maximum may never actually be reached because, with the extended time, enough evaporation or moisture expulsion may already be performed.

In some exemplary implementations, the substantially more air flow provided at the open cathode may be greater than a nominal amount (or another suitable amount of air flow predetermined for cold ambient temperatures) by a factor of 3 or more, 5 or more, 8 or more, or even 10 or more. The air blast may comprise one of at least 200%, at least 250% and at least 300% of the prior air flow, for example.

In some implementations, a duration of the blast may be related to the amount of blast. For example, if the blast causes 10 times the amount of air flow, then the duration may be extremely short (e.g., about 1-2 seconds); but if the blast causes only about 3 times the amount of air flow, then the duration may be a little longer (e.g., about 2-3 seconds). And the duration may alternatively or in addition be based on how quickly the air flow is made to speed or spool up, then back down. In some implementations, a configuration of air mover(s) 60 may be selected or determined based on how quickly the blast may be provided. As such, a duration of the performed adjustment may be determined based on a cubic meter per minute (CMM) flow of the fluid estimated to be received at stack 50. In some exemplary implementations, at least one of a duration of the performed adjustment and a periodicity of the performed adjustment may be determined based on a manner in which the FC stack responded to a previous adjustment. For example, when the blast amount was insufficient previously, then a blast amount in a subsequent period may be increased. The periodicity may even be predetermined such that the attribute (e.g., voltage or moisture) is prevented from being sensed at a value that is considered dangerous.

In some exemplary implementations, the adjustment may be deemed successful, when a gain in performance is subsequently observed. For example, just a few seconds later the stack voltage or the cell voltages may increase.

In some exemplary implementations, air movement may be directed at and/or from (see, e.g., FIGS. 2A-4B) a surface of FC stack 50 (e.g., which may comprise cathode electrode inlet(s) or outlet(s)). This directing of the air flow may be performed via controller 65, air mover(s) 60, and manifold 64, e.g., the latter of which comprising a boundary, border, pipe, or chamber formed around the fluid for guiding it towards or away the stack. Manifold 64 may have a plurality of apertures and/or pathways, e.g., in direct proximity of or in direct contact with an interior or inlet of system 10, a surface or electrode of stack 50, one or more air movers 60 (including combinations of air movers of one or more different types), bleed-off conduit 62, and/or another opening.

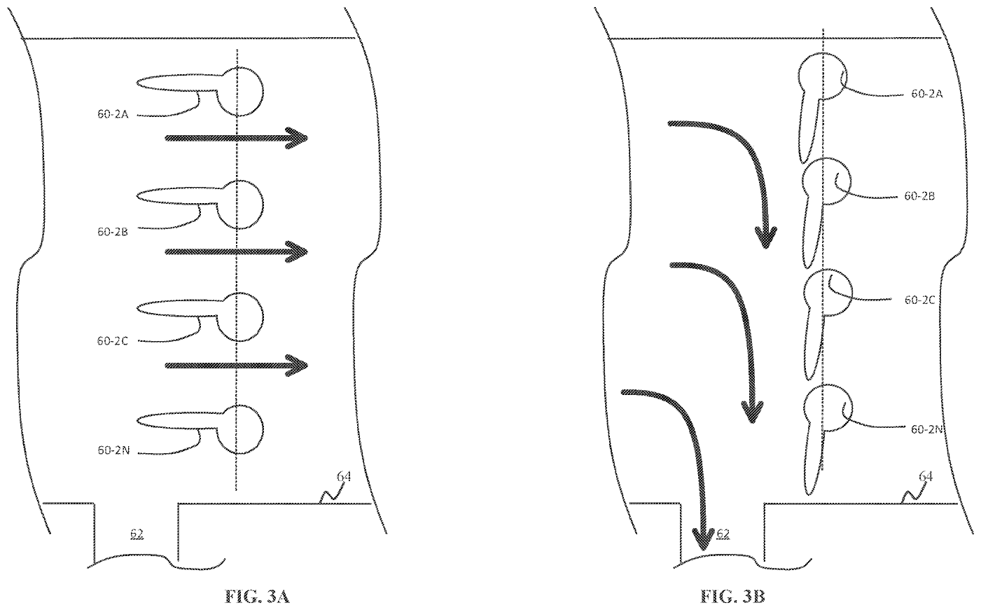

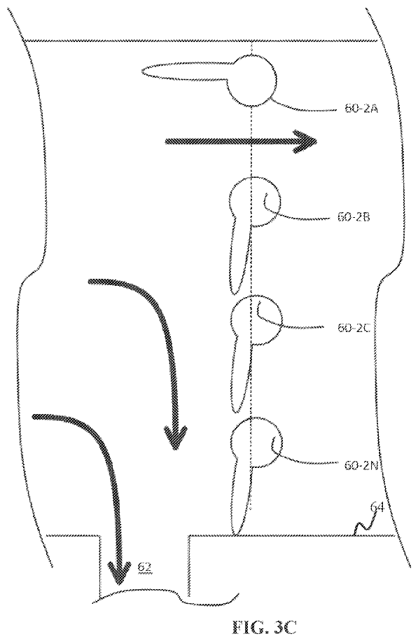

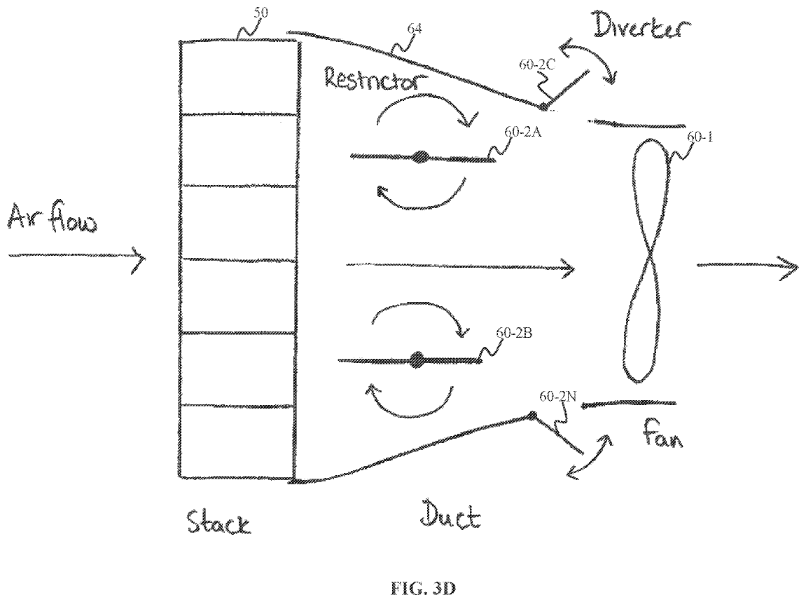

The mentioned air movement may be adjusted, e.g., via controller 65. For example, a blast of air may be blown at a cathode inlet, and/or a blast may suck air from a cathode outlet. Whether pushing or pulling the air may be determined, e.g., by system 10 constraints when designing it. For example, when trying to squeeze system 10 into the smallest possible volume, that may force a choice of one approach over another. One consideration is that ideally the air flow to a cathode inlet should be uniform. Fans create turbulence in the air flow immediately downstream from them so, if there is insufficient distance between a fan pushing the air and the cathode inlet, then the air received at the cathode inlet may not be totally uniform, potentially causing problematic variations in cooling in the stack. In this scenario, air would be better sucked from the cathode outlet, as depicted in the examples of FIGS. 2C and 3D. However, there is an advantage to having the fan in blow configuration. If blowing, then the fan may be moving cold ambient air, rather than hot exhaust air. Cold air is more dense than hot air so controller 65 may be causing more molecules/mass to move for a given volume of air moved. Therefore, this will cause a greater cooling potential, as the ability to cool a stack is related to the mass of the air moved through it.

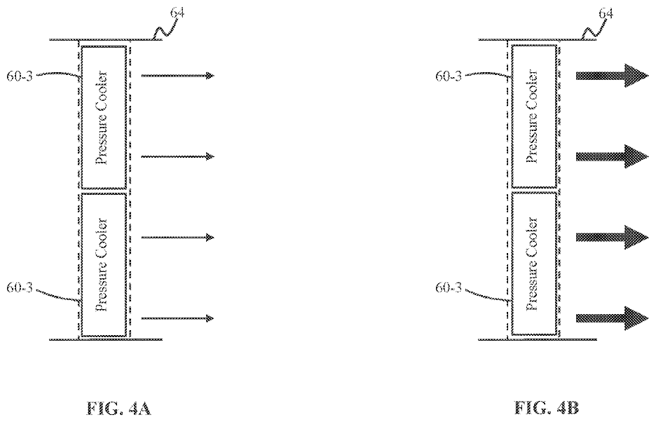

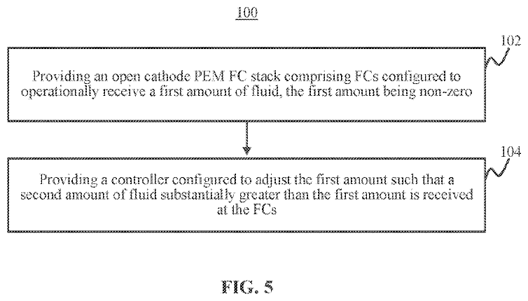

Although 60-1 is depicted as a fan in FIGS. 2A-2B, a pressure blower is also contemplated instead of such air moving fans as cross-flow, centrifugal, and axial-flow fans. Similarly, although 60-2 is depicted as a louver in FIGS. 3A-3B, another fluid-blocking and/or fluid-diverting device (e.g., a strip, slat, or another suitable structure) is also contemplated instead of an air moving louver. FIGS. 4A-4B depict another way to cool stack 50, including via pressurized means (e.g., a bellow, pair of bellows, air cooled pressurized (ACP), or another device that compresses and expands). PEM stack 50 may be air-cooled, although in some instances the cooling may instead or additionally be performed using a coolant. In FIGS. 2A, 2B, 4A, and 4B, air flow is depicted via arrows, thicker lines implying a greater amount of fluid flow thereabout. FIG. 4B, though, may also or instead show, by its thicker arrows, that more cooling is being applied via cooler 60-3 (e.g., comprising means for providing pressurized air, a heat exchanger, and/or a refrigeration cycle that includes a condenser, compressor, evaporator, and pump). In FIGS. 3A, 3B, and 3C, air flow is depicted via arrows, but a small amount of air flow may traverse past louvers 60-2, as depicted in the example of FIG. 3C (e.g., by opening one or more of the louvers while keeping the others closed); and an even smaller amount of air flow may trickle past louvers 60-2 of the example of FIG. 3B, for providing a nominal or non-zero air flow to stack 50.

Further contemplated to operate as an adjustable air mover (alone or with another aforementioned apparatus) is an airflow generator that uses the Coandă effect, electrostatic fluid accelerator, or another suitable device.

In some implementations, air mover(s) 60 may work at very high speeds and/or be configured to drive air (e.g., at different angles) with respect to the open-cathode surface of FC stack 50. In an example, air may be caused to blow at the stack; in another example, air may be caused to blow away from the stack. When axial fans are implemented their blades may have any number, shape, and dimensions to force air away from it over a broad area or specifically at one or more locations of FC stack 50. In some implementations, fans 60-1 may accelerate rapidly and/or reach a higher maximum velocity. The higher the acceleration and/or the higher the maximum velocity, the shorter the adjustment duration is determined to be.

In some exemplary implementations, manifold 64 of FIGS. 2-4 may have within it at least one of fan assembly 60-1, louver assembly 60-2, and cooling assembly 60-3. And these components may be configured in any suitable order or arrangement (e.g., between the fluid inlet and FC stack 50, as depicted in the example of FIG. 1B, or at another suitable location in system 10) such that substantially different volumes of a fluid (e.g., pressure-cooled air, forced air, or another fluid) are provided.

In some exemplary implementations, louver assembly 60-2 may control fluid flow directed at (e.g., by being in a housing or manifold having at least upper and lower walls, as depicted in FIGS. 2A-4B) FC stack 50. For example, the housing may have a rectangular cross-section. In some exemplary implementations, louver assembly 60-2 may comprise any natural number of louvers (e.g., arranged in an array), which may extend substantially perpendicular to the fluid flow through the housing or manifold. Each of the louvers may have any suitable shape, e.g., extending across a full width of the housing. The louvers may each be rotatable for controlling the fluid flow to a surface of FC stack 50. For example, the louvers may each be rotatable about their axis, which extends into and out of the page in the view shown in FIGS. 3A-3C. And they may be rotatable between a closed position (FIG. 3B), in which louver assembly 60-2 may restrict and/or divert at least a portion of the fluid flow, and an open position (FIG. 3A), in which louver assembly 60-2 may permit substantially all of the fluid flow through to FC stack 50.

In the closed position, as shown in FIG. 3B, each of the louvers has rotated such that the louvers come closer to contacting one another; and the louvers at the upper and lower ends of the housing may contact the walls thereof. In this position louvers 60-2 may form somewhat of a blockage such that at least a portion of the fluid flow is diverted out of aperture 62 (e.g., for re-use in system 10). The position, such as rotational position, of the louvers may be actively controlled during operation of the FC stack. Further, the louvers may be connected together such that they rotate in unison.

In some exemplary implementations, bleed-off conduit 62 may be used for air recirculation or for diverting air away from stack 50. For example, the minimum air flow of an air mover such as a fan may still be providing too much air for stack 50, under cold temperature conditions. In other situations, such as when performing the blast, a maximum airflow may be provided by shutting off conduit 62.

In some exemplary implementations, air mover controller 65 may throttle or adjust air movers 60-1 of FIGS. 2A-2B such that substantially a maximum air flow is provided. For example, controller 65 may adjust the fan voltage or current. In this or another example, pulse-width modulation (PWM) may be used for controlling the fan, e.g., by having a desired rotation speed based on a determined duty cycle. For example, 100% of fan PWM may be achieved for about two seconds before turning it back down. In these or other exemplary implementations, air mover controller 65 may adjust air movers 60-2, e.g., as depicted at the dotted line of FIGS. 3A-3C, such that a substantially-maximum-available air flow is provided. One or more of these adjustments may be performed, e.g., when an ambient temperature external to FC stack 50 is determined to satisfy a coldness criterion.

At the fluid inlet of system 10 of FIG. 1B may be, e.g., a source of air, which provides oxidant for the FCs. In some exemplary implementations, fan assembly 60-1 may be upstream or downstream of louver assembly 60-2. In these or other implementations, air mover 60 may be configured to move an ingress fluid flow from the inlet of FIG. 1B through to each FC stack. Although FIG. 2A depicts two fans 60-1, any number of fans n is contemplated, n being a natural number. Each fan 60-1 may be selectively actuated and/or its speed controlled, together or individually. Fan assembly 60-1 may at least be controlled based on air mover controller 65, e.g., which may so control responsive to an output of sensor(s) 55, a time indication, a performance parameter of the FC stack, or another attribute.

In some exemplary implementations, the air blasting may preventatively be performed before a sensed parameter (e.g., voltage) starts to drop to avoid any performance degradation. But air mover controller 65 may alternatively be configured to periodically cause air blasts, e.g., when sensor 55 (which would otherwise be configured to monitor cell voltages or a stack voltage in real time) is not present in system 10.

The fluid inlet may introduce atmospheric air to system 10, e.g., for duct 64 and/or air mover(s) 60 to guide to flow passages at a cathode of each respective FC in stack 50, e.g., which may discharge the air from stack 50 to the open air (e.g., through a condenser where water is separated from the discharged air). In some implementations, fans 60-1 may cause atmospheric air or another fluid to flow via air intake manifold 64, which may be mounted onto the stack.

In the example of FIG. 3A, louver assembly 60-2 is controlled into in an open position. Air may directly ingress (or egress) a set of louvers 60-2 (e.g., 60-2A, 60-2B, 60-2C, 60-2N, N being a natural number) from a system 10 inlet without need for a fan assembly in duct 64, or this fluid may come from fan assembly 60-1 (which may instead directly receive the air); in either of these configurations the louvers may be directly adjacent or coupled to a surface of FC stack 50. Other configurations are contemplated, e.g., where the fan assembly is directly adjacent or coupled to the surface of the stack, the louvers being in between the air inlet and the fan assembly. Further contemplated are configurations where the fan assembly receives air directly from the system 10 inlet, without need for a louver assembly in duct 64.

As mentioned, the left side of each of FIGS. 3A and 3B may be an output of the fan or an air inlet of system 10. The right side of each of FIGS. 3A and 3B may be the FC stack or another type of air mover (e.g., when a fan is sandwiched in between the louver and the FC stack and when controller 65 performs the blast by coordinated adjustment of the function of multiple types of air movers).

In some exemplary implementations, system 10 may perform a fan pulse by leaving fan 60-1 running and simply having louvers 60-2 close (see FIG. 3B) to block the air flow. In some implementations, fan pulsing may be performed while stack 50 is in the process of being turned on and operational. Such pulsing may comprise temporarily turning the fan off (or blocking the airflow via louvers).

In some exemplary implementations, the adjustment caused by air mover controller 65 may be synchronized with a fan pulse such that the adjustment is performed after the fan pulse, since the fan pulse would cause stack 50 to heat up and since the subsequent blast would cool it back down.

FIG. 5 illustrates method 100 for temporarily blasting air in relation to one or more FCs of one or more FC stacks, in accordance with one or more embodiments. Method 100 may be performed with a computer system comprising one or more computer processors and/or other components. The processors are configured by machine readable instructions to execute computer program components. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 5 and described below is not intended to be limiting. In some embodiments, method 100 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of method 100 in response to instructions stored electronically on an electronic storage medium. The processing devices may include one or more devices configured through hardware, firmware, and/or software to be specifically designed for execution of one or more of the operations of method 100.

At operation 102 of method 100, an open cathode PEM FC stack may be provided. This stack may comprise FCs configured to operationally receive a first amount of fluid, the first amount being non-zero. As an example, fluid may ingress system 10, and at least a small amount of the air may be directed or forced before reaching FC stack 50. In some embodiments, operation 102 is performed by a processor component of system 10.

At operation 104 of method 100, a controller may be provided that is configured to adjust the first amount such that a second amount of fluid substantially greater than the first amount is received at the FCs. As an example, the fluid flow may substantially increase before reaching FC stack 50. In this or another example, the first and second amounts are volumes of air that pass at, near, and/or around (i) a cathode electrode outlet and/or (ii) a surface comprising cathode flow channels. In this or another example, the adjustment may further comprise a humidity purging at the anode side. The blast of air provided via the adjustment may cause a purge, which may be different from such purges known to flush liquid out of the FC stack, e.g., into a water storage tank. In some embodiments, operation 104 is performed by a processor component of system 10.

One or more of controllers 65, 20 may have electronic storage, such as electronic storage media that electronically stores information. The electronic storage media of electronic storage may comprise system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). The electronic storage may be (in whole or in part) a separate component within system 10, or the electronic storage may be provided (in whole or in part) integrally with one or more other components of system 10 (e.g., a user interface device, processor, etc.). The electronic storage may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. The electronic storage may store software algorithms, information obtained and/or determined by the processor, information received via user interface devices and/or other external computing systems, information received from external resources, and/or other information that enables system 10 to function as described herein.

The external resources may include sources of information (e.g., databases, websites, etc.), external entities participating with system 10, one or more servers outside of system 10, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to the external resources may be provided by other components or resources included in system 10. The processor, the external resources, the user interface device, the electronic storage, a network, and/or other components of system 10 may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM. UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

The user interface device(s) of system 10 may be configured to provide an interface between one or more users and system 10. The user interface devices are configured to provide information to and/or receive information from the one or more users. The user interface devices include a user interface and/or other components. The user interface may be and/or include a graphical user interface configured to present views and/or fields configured to receive entry and/or selection with respect to particular functionality of system 10, and/or provide and/or receive other information. In some embodiments, the user interface of the user interface devices may include a plurality of separate interfaces associated with the processors and/or other components of system 10. Examples of interface devices suitable for inclusion in the user interface device include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that the user interface devices include a removable storage interface. In this example, information may be loaded into the user interface devices from removable storage (e.g., a smart card, a flash drive, a removable disk) that enables users to customize the implementation of user the interface devices.

In some embodiments, the user interface devices are configured to provide a user interface, processing capabilities, databases, and/or electronic storage to system 10. As such, the user interface devices may include the processors, the electronic storage, the external resources, and/or other components of system 10. In some embodiments, the user interface devices are connected to a network (e.g., the Internet). In some embodiments, the user interface devices do not include the processor, the electronic storage, the external resources, and/or other components of system 10, but instead communicate with these components via dedicated lines, a bus, a switch, network, or other communication means. The communication may be wireless or wired. In some embodiments, the user interface devices are laptops, desktop computers, smartphones, tablet computers, and/or other user interface devices.

Data and content may be exchanged between the various components of the system 10 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose, the Internet Protocol (IP) defines addressing methods and structures for datagram encapsulation. Of course, other protocols also may be used. Examples of an Internet protocol include Internet Protocol version 4 (IPv4) and Internet Protocol version 6 (IPv6).

In some embodiments, the processor(s) of air mover controller 65 (and/or load controller 20) may form part (e.g., in a same or separate housing) of a user device, a consumer electronics device, a mobile phone, a smartphone, a personal data assistant, a digital tablet/pad computer, a wearable device (e.g., watch), augmented reality (AR) googles, virtual reality (VR) googles, a reflective display, a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, the processor is configured to provide information processing capabilities in system 10. The processor may comprise one or more of a digital processor, an analog processor, a digital circuit designed to process information, an analog circuit designed to process information, a state machine, and/or other mechanisms for electronically processing information. In some embodiments, the processor may comprise a plurality of processing units. These processing units may be physically located within the same device (e.g., a server), or the processor may represent processing functionality of a plurality of devices operating in coordination (e.g., one or more servers, the user interface devices, devices that are part of the external resources, the electronic storage, and/or other devices).

The processor of air mover controller 65 (and/or load controller 20) is configured via machine-readable instructions to execute one or more computer program components. The processor may be configured to execute the components by, software; hardware; firmware; some combination of software, hardware, and/or firmware; and/or other mechanisms for configuring processing capabilities on the processor.

Techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

Several embodiments of the disclosure are specifically illustrated and/or described herein. However, it will be appreciated that modifications and variations are contemplated and within the purview of the appended claims.

What is claimed is:

1. A system, comprising:
an open cathode proton-exchange membrane (PEM) fuel cell (FC) stack comprising a plurality of FCs configured to operationally receive a first amount of fluid, the first amount being non-zero; and
a controller configured to adjust the first amount such that a second amount of fluid substantially greater than the first amount is received at the FCs,
wherein the adjustment is performed responsive to at least one of (i) a sensed attribute of one or more of the FCs changing by an amount that satisfies a danger criterion and (ii) an elapsed time of operation of the FC stack satisfying a periodicity criterion, and
wherein the adjustment causes the elapsed time to satisfy an endurance criterion.

2. The system of claim 1, wherein the adjustment causes moisture from one or more cathode side electrodes to be removed or evaporated such that the moisture does not block the fluid from diffusing to the respective electrode(s).

3. The system of claim 1, wherein the sensed attribute comprises at least one of a voltage and moisture indication.

4. The system of claim 1, wherein the performance of the adjustment is further responsive to an ambient temperature external to the FC stack satisfying a coldness criterion.

5. The system of claim 1, wherein the performance of the adjustment is further responsive to an ambient humidity external to the FC stack satisfying a moistness criterion.

6. The system of claim 1, wherein a duration of the performed adjustment is determined based on a cubic meter per minute (CMM) flow of the received fluid.

7. The system of claim 6, wherein the duration of the performed adjustment is further determined based on (i) a time needed to ramp up from the first amount to the second amount and (ii) a time needed to ramp down from the second amount to the first amount.

8. The system of claim 1, wherein at least one of a duration of the performed adjustment and a periodicity of the performed adjustment is determined based on a manner in which the FC stack responded to a previous adjustment.

9. The system of claim 1, wherein the periodicity criterion is predetermined such that the sensed attribute is prevented from satisfying the danger criterion.

10. The system of claim 1, wherein the second amount is greater than the first amount by a factor of 3 or more.

11. The system of claim 1, wherein the fluid is received over a surface of the FC stack.

12. The system of claim 4, wherein the coldness criterion is 5° C.

13. The system of claim 1, wherein the controller performs the adjustment by controlling a duty cycle of an air mover.

14. The system of claim 1, wherein the controller performs the adjustment by controlling at least one of a restrictor and diverter coupled to the FC stack or to a duct of the FC stack.

15. The system of claim 1, wherein the controller performs the adjustment by controlling a set of pressurized bellows.

16. The system of claim 1, wherein the system is mounted in an unmanned aerial vehicle (UAV).

17. The system of claim 1, wherein a fan pulse, which causes a temporary reduction in air flow by (i) temporarily stopping the fan and/or (ii) using an air blocking device, and the adjustment are synchronized such that the adjustment is performed after the fan pulse.

18. The system of claim 4, wherein a core temperature of the FC stack is determined based on the ambient temperature.

19. The system of claim 14, wherein ram air is received at the FCs, while the system is in motion, based on the control of the controller.

20. A method, comprising:
providing an open cathode proton-exchange membrane (PEM) fuel cell (FC) stack comprising a plurality of FCs configured to operationally receive a first amount of fluid, the first amount being non-zero; and
providing a controller configured to adjust the first amount such that a second amount of fluid substantially greater than the first amount is received at the FCs,
wherein the adjustment is performed responsive to at least one of (i) a sensed attribute of one or more of the FCs changing by an amount that satisfies a danger criterion and (ii) an elapsed time of operation of the FC stack satisfying a periodicity criterion, and
wherein the adjustment causes the elapsed time to satisfy an endurance criterion.
